(19) United States
(12) Patent Application Publication
(10) Pub. No.: US 2012/0120681 A1
(43) Pub. Date: May 17, 2012

(54) OPERATION PORTION ILLUMINATING MECHANISM AND OPERATION MECHANISM

(75) Inventor: Yousuke YAMASAKI, Machida-shi (JP)

(73) Assignee: NIKON CORPORATION, Tokyo (JP)

(21) Appl. No.: 13/295,555

(22) Filed: Nov. 14, 2011

(30) Foreign Application Priority Data
Nov. 16, 2010 (JP) 2010-256080
Nov. 2, 2011 (JP) 2011-241432

(51) Int. Cl. F21V 8/00; F21V 13/04; F21V 5/00

(52) U.S. Cl. 362/611; 362/311.01; 362/311.14; 362/308; 362/260

(57) ABSTRACT

An operation portion illuminating mechanism comprises: an operation tool that comprises a conductive portion and an operation member with optical transparency; and an illumination tool for illuminating the operation member from the installation side of the conductive portion, wherein the shape of the operation member around the conductive portion is formed as a shape in which the illumination light from the illumination tool is refracted so that the illumination light evenly illuminates the surface of the operation member facing the installation side of the conductive portion.

### BACKGROUND

1. Field of the Invention

The present invention relates to an operation portion illuminating mechanism and an operation mechanism.

Priority is claimed on Japanese Patent Application No. 2010-256080, filed on Nov. 16, 2010, and Japanese Patent Application No. 2011-241432, filed on Nov. 2, 2011, the contents of which are incorporated herein by reference.

2. Description of Related Art

Hitherto, there is demand for a technique for improving visibility of an operation portion at night or in a dark place. For example, Japanese Patent Application Publication No. 2009-86436 discloses an illumination device that includes a light guiding sheet that illuminates a button. Japanese Patent Application Publication No. 2007-199362 discloses a structure in which a light guide is held by an exterior member.

### SUMMARY

However, in Japanese Patent Application Publication No. 2009-86436, the light may be emitted in one direction by using the light guiding sheet, but it is difficult to illuminate a button formed as a rubber switch.

In Japanese Patent Application Publication No. 2007-199362, the position of the index (power LED window exposure portion) may be visually recognized by the illumination light from the light guide, but it is difficult to determine the state of the mode dial at night or in a dark place.

An object of aspects of the invention is to provide an operation portion illuminating mechanism and an operation mechanism capable of improving visibility of an operation portion at night or in a dark place.

An operation portion illuminating mechanism of an aspect includes: an operation tool that comprises a conductive portion and an operation member with optical transparency; and an illumination tool that illuminates the operation member from an installation side of the conductive portion, wherein a shape of the operation member around the conductive portion has a shape in which illumination light from the illumination tool is refracted so that illumination light evenly illuminates the surface of the operation member facing an installation side of the conductive portion.

An operation mechanism of another aspect includes the operation portion illuminating mechanism.

According to the aspects of the invention, it is possible to improve the visibility of the operation portion at night or in a dark place. Further, it is possible to provide the operation mechanism including the operation portion illuminating mechanism.

### BRIEF DESCRIPTION OF THE DRAWINGS

FIG. 1 is a perspective view illustrating an operation mechanism of a first embodiment of the invention.

FIG. 2 is a cross-sectional view illustrating the operation mechanism.

FIG. 3 is a cross-sectional view illustrating a first modified example of the operation member.

FIG. 4 is a cross-sectional view illustrating a second modified example of the operation member.

FIG. 5 is a cross-sectional view illustrating a third modified example of the operation member.

FIG. 6 is a cross-sectional view illustrating a fourth modified example of the operation member.

FIG. 7 is a cross-sectional view illustrating an operation mechanism of a second embodiment of the invention.

FIG. 8 is a cross-sectional view illustrating an operation mechanism of a third embodiment of the invention.

FIG. 9 is a cross-sectional view illustrating the operation mechanism of a fourth embodiment of the invention.

FIG. 10 is a cross-sectional view illustrating the operation mechanism of a fifth embodiment of the invention.

### DESCRIPTION OF EMBODIMENTS

Hereinafter, embodiments of the invention will be described by referring to the accompanying drawings. These embodiments represent aspects of the invention, are not to be understood as limiting the invention, and may be arbitrarily modified within the scope of the technical concept of the invention. Further, in the drawings below, the scales or the number of respective structures may be different from those of the actual structures for easy understanding of the respective configurations.

### First Embodiment

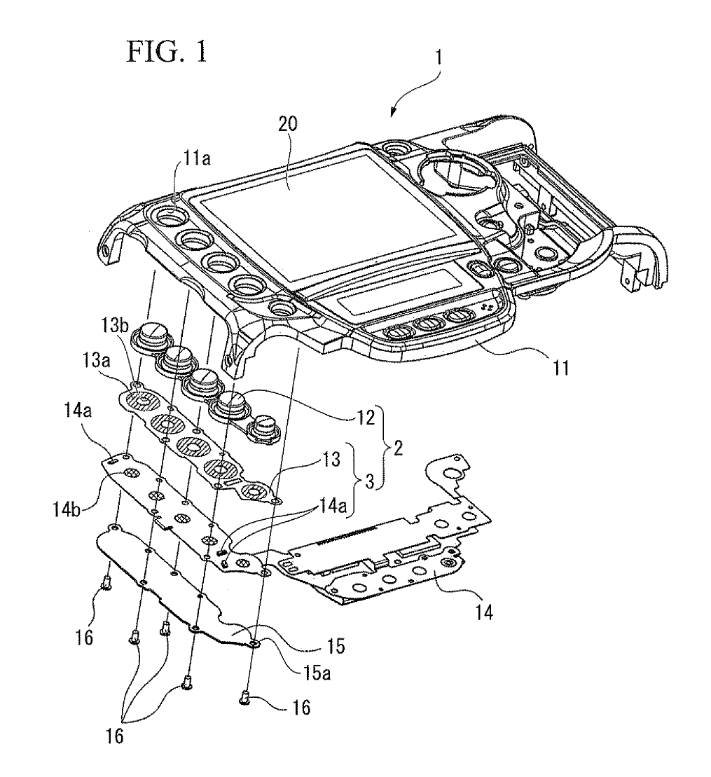

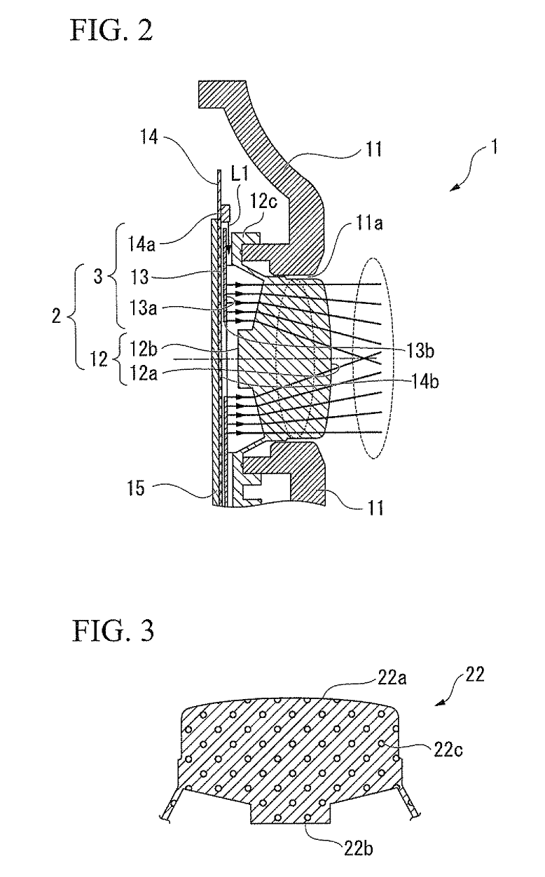

FIG. 1 is a perspective view illustrating an operation mechanism of a first embodiment of the invention. FIG. 2 is a cross-sectional view illustrating the operation mechanism.

An operation mechanism 1 is an operation mechanism that includes illumination tool for illuminating a button so as to improve visibility of the button (operation member) at night or in a dark place, and is applied to, for example, an operation portion in an image capturing apparatus such as a camera.

As shown in FIG. 1, the operation mechanism 1 includes an operation portion illuminating mechanism 2, a cover 11, a flexible substrate 14, a keep plate 15, and a screw 16.

The operation portion illuminating mechanism 2 includes operation tool 12 and illumination tool 3 for illuminating the operation tool 12.

The operation tool 12 includes a button 12a and a conductive portion 12b. The button 12a is an operation member with optical transparency, and is formed of, for example, a rubber member such as silicon rubber. The button 12a may be formed such that a top button portion touched by a user's finger is integrally molded with a protrusion of a rear surface of the button (the opposite side of the top button portion) by a rubber member or a resin member such as plastic.

Although not shown in the drawings, the top button portion of the button 12a is painted in white with optical transparency, and black printing is performed thereon. Accordingly, light comes out only from the white portion (the portion without the black printing) of the button 12a when the illumination tool 3 emits light.

A plurality of (for example, five) operation tools 12 are provided at the operation mechanism 1. The buttons 12a are arranged in a row next to the display portion 20. The buttons 12a are arranged corresponding to the configuration of the fingers of the human hand. Accordingly, it is possible to improve the operability.

The display portion 20, for example, is a liquid crystal display. The display portion 20 displays such as picture image data acquired by imaging or an operation screen by the operation tool 12.

The button 12a includes a configuration that has a dust proofing performance and a water proofing performance. As shown in FIG. 2, the button 12a has a skirt portion 12c such that the periphery portion of the button 12a spreads out like a skirt. In one example, the button 12a employs a silicon skirt. For example, the button 12a is made of silicon rubber. The skirt portion 12c of the button 12a is crooked in “L” shape when viewed in a cross-section direction. The crooked portion of the skirt portion 12c abuts on a portion opposing the light guiding plate 13 of the edge portion of the cover 11. The skirt portion 12c of the button 12a and the edge portion of the cover 11 are configured so that no gap is made there between. Because of this constitution, grit, dust or water droplets are prevented from entering into the inside of the operation mechanism 1 from between the button 12a and the cover 11.

The conductive portion 12b is provided at the rear surface of the button 12a. The conductive portion 12b is formed of, for example, a material including carbon, and does not transmit light therethrough. The conductive portion 12b becomes electrically connected to a conductive portion 14b provided on the flexible substrate 14 when the button 12a is pressed.

The illumination tool 3 employs a side light system (an edge light system). The illumination tool 3 includes a light guiding plate 13, an LED (a light source) 14a that makes light be incident to the end surface of the light guiding plate 13, and a light emitting portion 13a that emits light propagated through the light guiding plate 13 toward the button 12a. In the embodiment, the LED 14a is provided on the flexible substrate 14.

The light guiding plate 13 is disposed so as to face the rear surface of the button 12a. The light guiding plate 13 is provided with penetration holes 13b which have circular shapes in the plan view and do not disturb the contact between the conductive portion 12b of the rear surface of the button 12a and the conductive portion 14b of the flexible substrate 14 when the button 12a is pressed. A light emitting portion 13a having an annular shape in the plan view is formed around the penetration holes 13b of the light guiding plate 13.

The light emitting portion 13a may be formed by printing reflective dots on, for example, an acrylic plate using white ink. Furthermore, in order to suppress light emission, the light emitting portion 13a may be formed by printing reflective dots on, for example, an acrylic plate using black ink.

Light L1 which is incident from the LED 14a to the end surface of the light guiding plate 13 spreads in a wide area of the light guide plate 13 by repeating total reflection thereof. At this time, when there are reflective dots, the light L1 is scattered at the reflective dots. The light having an angle smaller than the total reflection angle in the corresponding light reflected by the reflective dots is emitted from the surface of the light guiding plate 13. In this way, the light emitted from the LED 14a is taken out from the light emitting portion 13a of the light guiding plate 13.

The cover 11 is an exterior component that fixes the component of the operation mechanism 1. The cover 11 includes an opening 11a at a position where the button 12a is installed. The opening 11a is a portion from which the top button portion of the button 12a is exposed. Although not shown in the drawings, the cover 11 is provided with an attachment hole to which the screw 16 is attached.

The flexible substrate 14 is disposed between the light guiding plate 13 and the keep plate 15. The flexible substrate 14 is provided with the LED 14a and the conductive portion 14b. Although not shown in the drawings, the flexible substrate 14 is provided with various kinds of interconnections (for example, a signal interconnection used to transmit a signal generated when the conductive portion 12b of the rear surface of the button 12a comes into contact with the conductive portion 14b) or a control circuit.

The keep plate 15 is a member that fixes the operation portion illuminating mechanism 2 and the flexible substrate 14 to the cover 11. The keep plate 15 is formed with a plurality of openings 15a. When the screw 16 is inserted through each opening 15a and the screw 16 is attached to an attachment hole (not shown) of the cover 11, the cover 11 and the keep plate 15 are fixed.

As shown in FIG. 2, the shape of the rear surface of the button 12a is formed as a shape in which the portion provided with the conductive portion 12b protrudes toward the light guiding plate 13. Further, the shape of the button 12a around the conductive portion 12b is formed as a shape in which the area of the cross-section cut along the plane parallel to the top surface of the light guiding plate 13 becomes larger as it becomes farther from the light guiding plate 13. In other words, as shown in FIG. 2, the shape of the button 12a around the conductive portion 12b is formed as an inclined linear shape in which the distance between the light guiding plate 13 and the button 12a in the cross-sectional view becomes shorter as it becomes closer to the conductive portion 12b. That is, the shape of the button 12a around the conductive portion 12b is formed as a shape in which the illumination light from the illumination tool 3 is refracted so as to evenly radiate the surface (the surface of the operation member) of the top button portion facing the installation side of the conductive portion 12b.

In the present embodiment, the button 12a around the conductive portion 12b has a shape that inclines with respect to a vertical direction of the incidence direction of the illumination light into the button 12a so that the illumination light from the illumination tool 3 illuminates the button 12a facing the installation side of the conductive portion 12b. Here, “the incidence direction of the illumination light from the illumination tool 3 into the button 12a” is a same direction as the normal line direction of the upper surface (the surface that the light from the LED 14a is brought out at the light emitting portion 13a of the light guiding plate 13) of the light guiding plate 13.

In the embodiment, the shape of the button 12a around the conductive portion 12b is formed as a shape in which the light incident into the button 12a from the position close to the conductive portion 12b is refracted to a relatively large degree and the light incident into the button 12a from a position distant from the conductive portion 12b is refracted to a relatively small degree. Furthermore, the shape of the button 12a around the conductive portion 12b is not limited thereto, and may be formed as a shape in which the light incident into the button 12a from a position close to the conductive portion 12b is refracted to a relatively small degree and the light incident into the button 12a from a position distant from the conductive portion 12b is refracted to a relatively large degree.

The light emitted from the light emitting portion 13a of the light guiding plate 13 is incident to the button 12a from the portion around the conductive portion 12b of the rear surface of the button 12a. Part of the light incident into the button 12a from the portion around the conductive portion 12b is refracted toward the top button area of the button 12a facing the conductive portion 12b due to the shape of the button 12a around the conductive portion 12b. Accordingly, the light may be evenly emitted from the surface of the top button portion compared to, for example, a configuration in which the shape of the button around the conductive portion is flat (a configuration in which the light is scarcely incident to the portion facing the conductive portion).

According to the operation portion illuminating mechanism 2 of the embodiment, it is possible to evenly illuminate the surface of the top button portion present at the side facing the installation side of the conductive portion 12b due to the illumination light from the illumination tool 3. For example, when the top button portion of the button 12a is painted in white with optical transparency and black printing is performed on the white painted portion so as to recognize the function of the button 12a, light comes out only from the white portion of the button 12a when the illumination tool 3 emits light. Accordingly, it is possible to improve visibility of the button 12a at night or in a dark place.

Further, according to this configuration, since the side light system is adopted, it is possible to decrease the thickness of the operation portion illuminating mechanism 2 compared to the configuration adopting a directly below system.

Further, according to this configuration, since the light emitting portion 13a is formed in an annular shape, it is possible to selectively input illumination light to the portion around the conductive portion 12b in the rear surface of the button 12a. Accordingly, it is possible to highly efficiently emit light from the button 12a without any loss of light.

According to the operation mechanism 1 of the embodiment, since the above-described operation portion illuminating mechanism 2 is provided, it is possible to improve the visibility of the button 12a at night or in a dark place.

Furthermore, in the embodiment, the button 12a is integrally molded by a rubber member, but the invention is not limited thereto. For example, the top button portion touched by the user's finger may be molded by a resin member such as plastic, and the other portions may be molded by a rubber member. Accordingly, it is possible to improve the operation feel of the button.

Furthermore, in the embodiment, a configuration has been described in which a button is used as the operation member of the operation portion illuminating mechanism, but the invention is not limited thereto. For example, the invention may be applied to a configuration in which a dial, a pad, or the like is used as the operation member.

Furthermore, in the embodiment, the side light system is adopted in the illumination tool, but the invention is not limited thereto. For example, a directly under system may be adopted.

Furthermore, in the embodiment, a case has been described in which a mechanism of an operation portion of an image capturing apparatus such as a camera is exemplified as the operation mechanism, but the invention is not limited thereto. For example, the invention may be applied to even a mechanism of an operation portion in an electronic apparatus such as a cellular phone and a mechanism of an operation portion in a panel portion or a door portion of an automobile.

### First Modified Example of First Embodiment

FIG. 3 is a cross-sectional view illustrating a first modified example of the operation mechanism. Furthermore, in FIG. 3, only the operation tool constituting the operation mechanism is shown, and the other components are not shown.

Operation tool 22 according to the modified example is formed in a manner such that a button 22a disperses optical diffusion particles 22c through a resin with optical transparency.

According to the configuration of the modified example, the illumination light from the illumination tool 3 is diffused by the optical diffusion particles 22c when the illumination light is transmitted through the button 22a, thereby further evenly illuminating the surface of the top button portion.

### Second Modified Example of First Embodiment

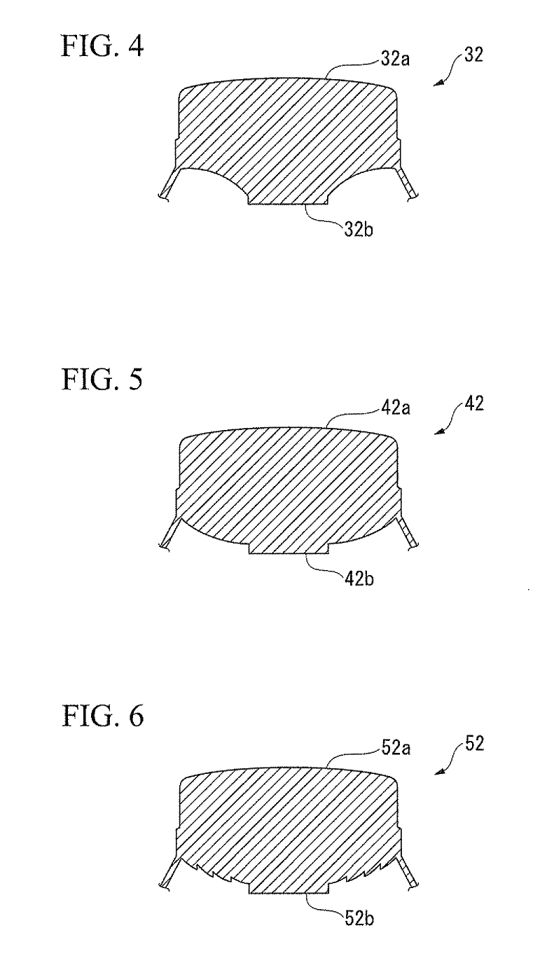

FIG. 4 is a cross-sectional view illustrating a second modified example of the operation mechanism. Furthermore, in FIG. 4, only the operation tool constituting the operation mechanism is shown, and the other components are not shown.

In operation tool 32 according to the modified example, the shape of a button 32a around a conductive portion 32b is formed in a curved shape that is depressed toward the light guiding plate 13 (not shown) (protrudes toward the surface of the top button portion) in the cross-sectional view. That is, the inclination of the tangential line of the curve becomes steeper as it approaches the conductive portion 32b. In this configuration, the shape of the button 32a around the conductive portion 32b is formed as a shape in which the light incident to the button 32a from a position close to the conductive portion 32b is refracted to a relatively large degree and the light incident to the button 32a from a position distant from the conductive portion 32b is refracted to a relatively small degree. Even in the configuration of the modified example, it is possible to evenly illuminate the surface of the top button portion.

### Third Modified Example of First Embodiment

FIG. 5 is a cross-sectional view illustrating a third modified example of the operation mechanism. Furthermore, in FIG. 5, only the operation tool constituting the operation mechanism is shown, and the other components are not shown.

In operation tool 42 according to the modified example, the shape of a button 42a around a conductive portion 42b is formed as a curved shape that protrudes toward the light guiding plate 13 (not shown) (is depressed toward the surface of the top button portion) in the cross-sectional view. That is, the inclination of the tangential line of the curve becomes gentler as it approaches the conductive portion 42b. In this configuration, the shape of the button portion 42a around the conductive portion 42b is formed as a shape in which the light incident to the button 42a from a position close to the conductive portion 42b is refracted to a relatively small degree and the light incident to the button 42a from a position distant from the conductive portion 42b is refracted to a relatively large degree. Even in the configuration of the modified example, it is possible to evenly illuminate the surface of the top button portion.

### Fourth Modified Example of First Embodiment

FIG. 6 is a cross-sectional view illustrating a fourth modified example of the operation mechanism. Furthermore, in FIG. 6, only the operation tool constituting the operation mechanism is shown, and the other components are not shown.

In operation tool 52 according to the modified example, the shape of a button 52a around a conductive portion 52b is formed in a Fresnel shape in the cross-sectional view. In this configuration, the shape of the button 52a around the conductive portion 52b is formed as a shape in which the light incident to the button 52a from a position close to the conductive portion 52b is refracted to a relatively large degree and the light incident to the button 52a from a position distant from the conductive portion 52b is refracted to a relatively small degree. Even in the configuration of the modified example, it is possible to evenly illuminate the surface of the top button portion.

### Second Embodiment

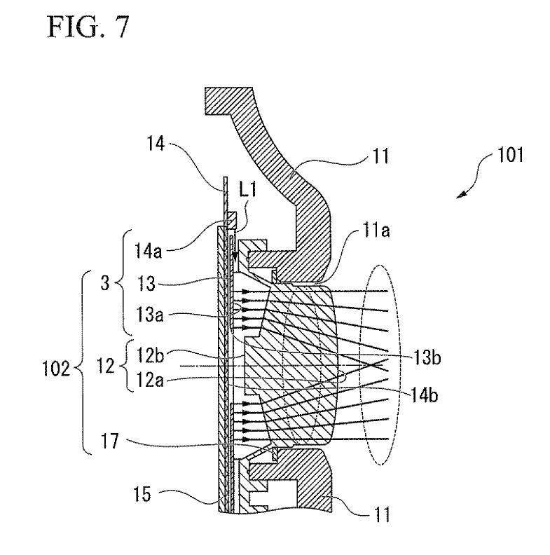

FIG. 7 is a cross-sectional view corresponding to FIG. 2 and illustrating an operation mechanism of a second embodiment of the invention.

As shown in FIG. 7, an operation mechanism 101 of the embodiment is different from the operation mechanism 1 of the first embodiment in that a light shielding member 17 is provided at the side portion of the button 12a. Since the other points are the same as those of the above-described configuration, the detailed description thereof will not be repeated by giving the same reference numerals to the same components as those of FIG. 2.

As shown in FIG. 7, the operation mechanism 101 includes an operation portion illuminating mechanism 102, the flexible substrate 14, the keep plate 15, and the screw 16 (not shown).

The operation portion illuminating mechanism 102 includes the operation tool 12, the illumination tool 3 for illuminating the button 12a, the cover 11 having the opening 11a provided at the installation position of the button 12a, and the light shielding member 17.

The light shielding member 17 is provided at the side portion of the button 12a. The light shielding member 17 may be formed, for example, in a manner such that an annular member is formed along the side surface of the button 12a and the member is painted in black. The light shielding member 17 is used to prevent the illumination light emitted from the light emitting portion 13a from leaking from a gap between the cover 11 and the button 12a.

According to the operation portion illuminating mechanism 102 of the embodiment, it is possible to prevent the illumination light from leaking around the button 12a. Accordingly, it is possible to more brightly illuminate the surface of the top button portion of the button 12a.

### Third Embodiment

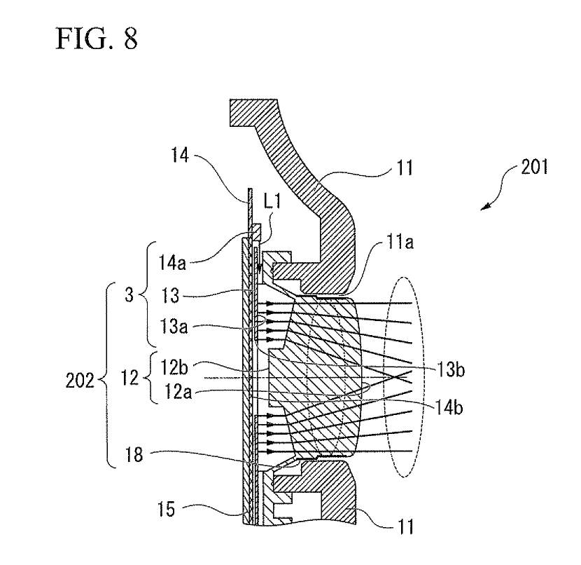

FIG. 8 is a cross-sectional view corresponding to FIG. 2 and illustrating an operation mechanism of a third embodiment of the invention.

As shown in FIG. 8, an operation mechanism 201 of the embodiment is different from the operation mechanism 1 of the first embodiment in that a light absorbing film 18 is formed on the side surface of the button 12a. Since the other points are the same as those of the above-described configuration, the detailed description thereof will not be repeated by giving the same reference numerals to the same components as those of FIG. 2.

As shown in FIG. 8, an operation mechanism 201 includes an operation portion illuminating mechanism 202, the cover 11, the flexible substrate 14, the keep plate 15, and the screw 16 (not shown).

The operation portion illuminating mechanism 202 includes the operation tool 12, the illumination tool 3 for illuminating the button 12a, and the light absorbing film 18.

The light absorbing film 18 is formed on the side surface of the button 12a. The light absorbing film 18 may be formed, for example, in a manner such that a material such as carbon black with a black color and an excellent light absorbing property is coated on the side surface of the button 12a. The light absorbing film 18 absorbs the illumination light from the light emitting portion 13a.

According to the operation portion illuminating mechanism 202 of the embodiment, it is possible to prevent the illumination light from leaking from the side surface of the button 12a. For this reason, the illumination light is used only to illuminate the surface of the top button portion. Accordingly, it is possible to more brightly illuminate the surface of the top button portion of the button 12a.

Furthermore, in the embodiment, the side surface of the button 12a is provided with the light absorbing film 18 that absorbs the illumination light, but the invention is not limited thereto. For example, the side surface of the button 12a may be provided with a light reflecting film reflecting the illumination light instead of the light absorbing film 18. The light reflecting film may be formed, for example, in a manner such that aluminum is deposited on the side surface of the button 12a. Accordingly, the light passing through the inside of the button 12a is prevented from leaking to the outside from the side surface, and the light is reflected, so that the reflected light is emitted from the surface of the top button portion. Therefore, it is possible to prevent light from leaking from the side surface of the button 12a and highly efficiently illuminate the surface of the top button portion of the button 12a.

Furthermore, the side surface of the button 12a may be provided with a fluorescent film which is excited by the illumination light and emits fluorescence instead of the light absorbing film 18. The fluorescent film may be formed, for example, in a manner such that a YAG (yttrium/aluminum/garnet) fluorescent material is coated on the side surface of the button 12a. Accordingly, the light passing through the inside of the button 12a is prevented from leaking to the outside from the side surface, and is absorbed by the fluorescent film to be radiated as fluorescence, so that the absorbed light is emitted from the surface of the top button portion. Accordingly, it is possible to highly efficiently illuminate the surface of the top button portion of the button 12a.

Furthermore, the light absorbing film, the light reflecting film, and the fluorescent film may be combined with each other.

### Fourth Embodiment

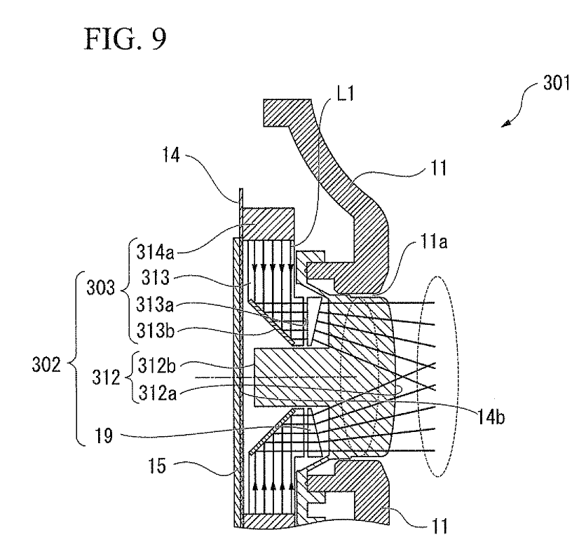

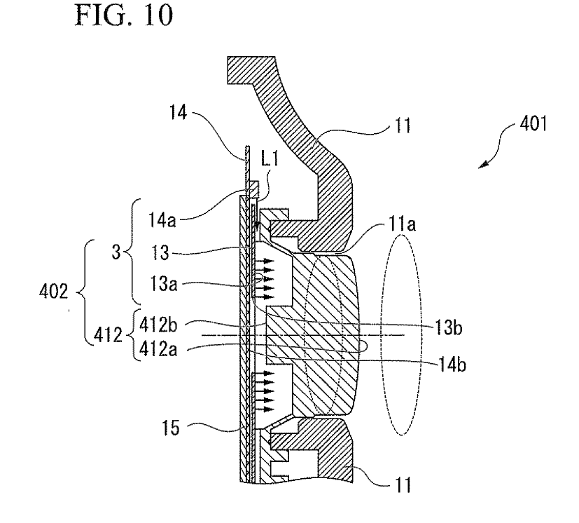

FIG. 9 is a cross-sectional view corresponding to FIG. 2 and illustrating the operation mechanism of the fourth embodiment of the invention.

As shown in FIG. 9, an operation mechanism 301 of the embodiment is different from the operation mechanism 1 of the first embodiment in that refraction tool 19 is provided around a conductive portion 312b so as to refract the light incident to a button 312a. Since the other points are the same as those of the above-described configuration, the detailed description thereof will not be repeated by giving the same reference numerals to the same components as those of FIG. 2.

As shown in FIG. 9, the operation mechanism 301 includes the operation portion illuminating mechanism 302, the cover 11, the flexible substrate 14, the keep plate 15, and the screw 16 (not shown).

The operation portion illuminating mechanism 302 includes operation tool 312, illumination tool 303 for illuminating the button 312a, and the refraction tool 19.

The operation tool 312 includes the button 312a and the conductive portion 312b. The portion provided with the conductive portion 312b of the button 312a is formed in a cylindrical shape. The length of the portion provided with the conductive portion 312b of the button 312a (the height of the cylinder) is set to a length in which the conductive portion 312b is electrically connected to the conductive portion 14b provided in the flexible substrate 14 when the button 312a (the top button portion) is pressed.

The illumination tool 303 employs a side light system (an edge light system). The illumination tool 303 includes a light guiding plate 313, an LED 314a that makes light be incident to the end surface of the light guiding plate 313, a light emitting portion 313a that emits light propagated through the light guiding plate 313 toward the button 312a, and a reflection mirror 313b that reflects light. The LED 314a is provided on the flexible substrate 14.

The light L1 which is incident from the end surface of the LED 314a to the end surface of the light guiding plate 313 is guided toward the reflection mirror 313b by repeating the surface reflection. The light is reflected at the reflection mirror 313b, and is guided toward the light emitting portion 313a by repeating the surface reflection. Then, the light having an angle smaller than the total reflection angle in the corresponding light in the light emitting portion 313a is emitted from the surface of the light guiding plate 313. In this way, the light emitted from the LED 314a is taken out from the light emitting portion 313a of the light guiding plate 313.

The refraction tool 19 is provided around the conductive portion 312b so as to be located between the light emitting portion 313a of the light guiding plate 313 and the button 312a. The refraction tool 19 is used to refract the light incident to the button 312a. The refraction tool 19 is formed in a shape in which the illumination light emitted from the illumination tool 303 is refracted so that the illumination light evenly illuminates the surface of the top button portion facing the installation side of the conductive portion 312b.

The light emitted from the light emitting portion 313a of the light guiding plate 313 is incident to the portion around the conductive portion 312b at the rear surface of the button 312a. At least a part of the light incident to the portion around the conductive portion 312b is refracted toward the area facing the conductive portion 312b of the surface which is opposite to the rear surface of the button 312a due to the shape of the refraction tool 19. Accordingly, for example, compared to a configuration (a configuration without the refraction tool 19) in which the shape of the button around the conductive portion is flat (a configuration in which light is scarcely incident to the portion facing the conductive portion) tool, it is possible to evenly illuminate the surface of the top button portion.

Even in the operation portion illuminating mechanism 302 of the embodiment, it is possible to improve visibility of the button 312a at night or in a dark place.

### Fifth Embodiment

FIG. 10 is a cross-sectional view illustrating the operation mechanism of the fifth embodiment of the invention that corresponds to FIG. 2. As shown in FIG. 10, the operation mechanism 401 of the embodiment is different from the operation mechanism 1 of the above-mentioned first embodiment to the extent of the shape of the button 412a around the conductive portion 412b is substantially flat.

As shown in FIG. 10, the operation mechanism 401 includes an operation portion illuminating mechanism 402, a cover 11, a flexible substrate 14 and a keep plate 15.

The operation portion illuminating mechanism 402 includes an operation tool 412 and an illumination tool 3 that illuminate the button 412a. The operation tool 412 includes the button 412a and a conductive portion 412b.

In the present embodiment, the button 412a around the conductive portion 412b has a substantially flat shape. Specifically, it is a surface that is vertical to the incidence direction of the illumination light from the illumination tool 3 into the button 12a. Here, “the incidence direction of the illumination light from the illumination tool 3 into the button 412a” is the same direction as the normal line direction of the upper surface (the surface that the light from the LED 14a is brought out at the light emitting portion 13a of the light guiding plate 13) of the light guiding plate 13.

In the embodiment, the button 412a is formed in a manner such that it disperses optical diffusion particles through a resin with optical transparency.

According to the configuration, the illumination light from the illumination tool 3 is able to illuminate the button 412a facing the installation side of the conductive portion 412b by dispersing the optical diffusion particles to the button 412a around the conductive portion 412b.

Even in the operation portion illuminating mechanism 402 of the embodiment, it is possible to improve the visibility of the button 412a at night or in a dark place.

1. An operation portion illuminating mechanism comprising:
an operation tool that comprises a conductive portion and an operation member with optical transparency; and
an illumination tool that illuminates the operation member from an installation side of the conductive portion;
wherein a shape of the operation member around the conductive portion has a shape in which illumination light from the illumination tool is refracted so that illumination light evenly illuminates the surface of the operation member facing an installation side of the conductive portion.

2. An operation portion illuminating mechanism comprising:
an operation tool that comprises a conductive portion and an operation member with optical transparency;
an illumination tool that illuminates the operation member from an installation side of the conductive portion; and
a refraction tool that refracts light incident to the operation member around the conductive portion,
wherein the refraction tool has a shape in which illumination light from the illumination tool is refracted so that illumination light evenly illuminates the surface of the operation member facing an installation side of the conductive portion.

3. The operation portion illuminating mechanism according to claim 1,
wherein the operation member is formed by dispersing optical diffusion particles in a resin with optical transparency.

4. The operation portion illuminating mechanism according to claim 1, further comprising:
a cover that has an opening at the installation position of the operation member,
wherein a light shielding member is provided at a side portion of the operation member so as to prevent the leakage of illumination light from a gap between the cover and the operation member.

5. The operation portion illuminating mechanism according to claim 1,
wherein a light absorbing film is formed on a side surface of the operation member so as to absorb the illumination light.

6. The operation portion illuminating mechanism according to claim 1,
wherein a light reflecting film is formed on a side surface of the operation member so as to reflect the illumination light.

7. The operation portion illuminating mechanism according to claim 1,
wherein a fluorescent film is formed on a side surface of the operation member.

8. The operation portion illuminating mechanism according to claim 1,
wherein the illumination tool comprises:
a light guiding plate,
a light source that makes light be incident to an end surface of the light guiding plate, and
a light emitting portion that emits light propagated through the light guiding plate toward the operation member.

9. The operation portion illuminating mechanism according to claim 8,
wherein the light emitting portion is formed in an annular shape.

10. The operation portion illuminating mechanism according to claim 1,
wherein the operation member is formed of rubber and plastic.

11. The operation portion illuminating mechanism according to claim 1,
wherein the operation member is a button.

12. An operation mechanism comprising:
the operation portion illuminating mechanism according to claim 1.

13. An operation portion illuminating mechanism which is used in a portable device, comprising:
an operation tool that comprises a conductive portion and an operation member with optical transparency; and
an illumination tool that illuminates the operation member from an installation side of the conductive portion;
wherein the operation portion illuminating mechanism is configured so that illumination light from the illumination tool illuminates the operation member facing an installation side of the conductive portion.

14. The operation portion illuminating mechanism according to claim 13,
wherein the operation member has a dust proofing performance and a water proofing performance.

15. The operation portion illuminating mechanism according to claim 14,
wherein the shape of the operation member around the conductive portion has a shape in which illumination light from the illumination tool is refracted so that illumination light illuminates the operation member facing an installation side of the conductive portion.

16. The operation portion illuminating mechanism according to claim 14,
wherein the shape of the operation member around the conductive portion inclines with respect to a vertical direction of an incidence direction of illumination light into the operation member so that illumination light from the illumination tool illuminates the operation member facing the installation side of the conductive portion.

17. The operation portion illuminating mechanism according to claim 14, further comprising:
a refraction tool that is provided around the conductive portion so as to refract a light incident to the operation member;
wherein the refraction tool has a shape in which illumination light from the illumination tool is refracted so that illumination light illuminates the operation member facing an installation side of the conductive portion.

18. The operation portion illuminating mechanism according to claim 14,
wherein the operation tool has a plurality of the operation member and the plurality of the operation member is arranged in a row.

19. The operation portion illuminating mechanism according to claim 14,
wherein the portable device has a display portion.

20. The operation portion illuminating mechanism according to claim 19,
wherein the display portion displays an operation screen by the operation tool.

21. The operation portion illuminating mechanism according to claim 14,
wherein the operation member is formed by dispersing an optical diffusion particles through a resin with optical transparency.

22. The operation portion illuminating mechanism according to claim 14, further comprising:
a cover that has an opening at the installation position of the operation member, wherein a light shielding member is provided at a side portion of the operation member so as to prevent the leakage of illumination light from a gap between the cover and the operation member.

23. The operation portion illuminating mechanism according to claim 14,
wherein a light absorbing film is formed on a side surface of the operation member so as to absorb the illumination light.

24. The operation portion illuminating mechanism according to claim 14,
wherein a light reflecting film is formed on a side surface of the operation member so as to reflect the illumination light.

25. The operation portion illuminating mechanism according to claim 14,
wherein a fluorescent film is formed on a side surface of the operation member.

26. The operation portion illuminating mechanism according to claim 14,
wherein the illumination tool comprises:
a light guiding plate,
a light source that makes light be incident to an end surface of the light guiding plate, and
a light emitting portion that emits light propagated through the light guiding plate toward the operation member.

27. The operation portion illuminating mechanism according to claim 26,
wherein the light emitting portion is formed in an annular shape.

28. The operation portion illuminating mechanism according to claim 14,
wherein the operation member is formed of rubber and plastic.

29. The operation portion illuminating mechanism according to claim 14,
wherein the operation member is a button.

30. An operation mechanism comprising:
the operation portion illuminating mechanism according to claim 14.
